(19) United States
(12) Patent Application Publication
(10) Pub. No.: US 2004/0168087 A1
(43) Pub. Date: Aug. 26, 2004

(54) Methods and apparatus for securing computer systems

(76) Inventors: David Mendenhall, North Bay Village, FL (US); Sterling Wharton, Marietta, GA (US); Chester Heath, Boca Raton, FL (US)

Correspondence Address: KAPLAN & GILMAN , L.L.P., 900 ROUTE 9 NORTH, WOODBRIDGE, NJ, 07095, US

(21) Appl. No.: 10/759,615

(22) Filed: Jan. 16, 2004

Related U.S. Application Data
(60) Provisional application No. 60/440,600, filed on Jan. 16, 2003.

(51) Int. Cl. G06F 11/30

(52) U.S. Cl. 713/201

(57) ABSTRACT

A computer system includes: a data-handling system operable to receive and transmit data over a data path; a storage device operatively coupled to the data-handling system to receive data from and deliver stored data to the data-handling system; and a security element operatively coupled between an external data path and the data-handling system via the data path, the security element establishing the data path as a trusted path, wherein the data-handling system, the storage device and the security element are disposed in a common physical housing such that access to the data path requires breach of the housing.

### CROSS REFERENCE TO RELATED APPLICATIONS

This application is based on and claims priority to U.S. Provisional Patent Application No. 60/440,600, filed Jan. 16, 2003, entitled POSITIVELY SECURED SYSTEMS, the entire disclosure of which is hereby incorporated by reference.

### BACKGROUND OF THE INVENTION

The ability to ensure security in a computer system in which data are transmitted over wide area and local networks to and from servers, client terminals and computers, databases, etc. has been a long-standing problem. The vulnerability of such computer systems is not limited to outside entities trying to gain access to sensitive information. Indeed, a 1996 FBI survey found that 80% of intrusion in data centers occurs from within the data center, i.e., from the inside. Incidents of unauthorized access to executive mail, financial and personnel records are often undetected and unreported.

A traditional approach to securing data servers, etc. of a given location (e.g., a building, a department, a client computer, etc.) is to employ a firewall or Virtual Private Network (VPN) to shield one or more servers (e.g., banks of servers or individual servers). Intrusion Detection Systems (IDSs) may monitor individual servers or groups of servers as well. This equipment is often required to be in a centralized location where physical security of the systems can be concentrated. Thus, this approach is often impractical in dispersed offices, branch locations or shared data centers.

To illustrate the above approach, reference is now made to FIG. 1, which illustrates a conventional approach to computer system security. The conventional topology 10 of a data center includes one or more servers 12, a database 14, and a security element 16. Typical data centers often evolve from a small number of servers 12 that are operatively coupled to the database 14 by way of communication lines 17. The server 12 stores data on the database 14, which is typically a number of disks. The server 12 and database 14 are housed in a physical cabinet 18 that is located inside a physically secured area 18.

The security element 16 is operatively coupled to the server 12 by way of a communication network 22. As the network 22 is protected from an un-trusted, outside world 24 by the security element 16, the network 22 is often referred to as a trusted network 22. The security element may be a firewall, an IDS, or a VPN.

These data center systems may be scaled according to capacity demands to systems having a large trusted network at the core. This is sometimes called a “Tootsie-Pop” structure because, by analogy, the system has a hard shell (secure) surrounding a soft center (un-secure). The soft center, i.e., the trusted network 22 often has little protection against internal intrusion, either by software hacking past user-id and password protection or physically tapping onto, or removing, a connection to a server within the trusted soft center to extract critical data.

Indeed, if the soft center (trusted network) 22 is shared by a number of network elements, such as other servers, databases, client terminals, etc., all the data traveling to and from the respective network elements may be on a common network, where it can be intercepted and recorded simply by impersonating the IP address of either the source or destination. To protect against unauthorized access, one could go to an extreme and define a security device, (firewall, VPN or IDS) for every server in the system. This would still leave the connection 22 between the security element 16 and the server 12 vulnerable to physical tapping, or removal.

Thus, there are needs in the art for new methods and apparatus for securing computer systems from breaches, particularly from within the sphere of protection of a trusted network.

### SUMMARY OF THE INVENTION

In general, the approach of the present invention is to provide an improved coupling of physical and logical security elements such as firewalls, intrusion detection systems and virtual private network systems even where servers are centralized and concentrated. Preferably the number of trusted individuals who would have access to signal lines carrying unsecured data is minimized. In this regard, the invention focuses on the fact that the data on disk, or the physical disk itself, is to be protected.

In accordance with one or more aspects of the present invention, a computer system includes: a data-handling system operable to receive and transmit data over a data path; a storage device operatively coupled to the data-handling system to receive data from and deliver stored data to the data-handling system; and a security element operatively coupled between an external data path and the data-handling system via the data path, the security element establishing the data path as a trusted path. The data-handling system, the storage device and the security element are disposed in a common physical housing such that access to the data path requires breach of the housing.

In accordance with one or more further aspects of the present invention, a computer system includes: a data-handling system operable to receive and transmit data over a data path; a storage device operatively coupled to the data-handling system to receive data from and deliver stored data to the data-handling system; and a security element operatively coupled between an external data path and the data-handling system via the data path, the security element establishing the data path as a trusted path. The security element is disposed in a separate physical housing from the data-handling system and the storage device, and the data path is encased in an armored sheath operable to substantially resist access to the data path by unauthorized entities.

The computer system preferably further includes one or more anti-tamper devices integrated with one or more connectors of the data path, the anti-tamper devices resisting removal of the one or more connectors from at least one of the data-handling system and the security device. The anti-tamper devices are operable to permanently damage at least one of themselves and mating connectors thereof in order to substantially resist access to the data path by unauthorized entities.

For example, the anti-tamper devices may include at least one barb that interlocks with a mating element of a mating connector such that the connector may not be removed from the mating connector without damaging at least one of the connector and mating connector in order to substantially resist access to the data path by unauthorized entities. Fir example, the at least one barb may be formed from a flexible yet sturdy metal that is biased in an outward direction away from the connector; and the mating connector includes one or more corresponding ridges, channels, and/or protrusions that engage the at least one barb to fixedly couple the connector and the mating connector together.

The computer system preferably further includes an intelligent device coupled along the data path that is operable to detect a decoupling of the security element from the data-handling system and to take action in response. The intelligent device maybe operable to sound an alarm when decoupling of the security element from the data-handling system is detected. The alarm may be directed to a specific network address. The intelligent device may be operable to record that decoupling of the security element from the data-handling system is detected.

The intelligent device is preferably operable to sense a lack of current to receiving drivers in either the data-handling device or the security element in order to detect a decoupling of the security element from the data-handling system. The intelligent device is preferably operable to open the data path between the data-handling device and the security element in response to a decoupling of the security element from the data-handling system. For example, the intelligent device may be operable to open a fusible circuit in response to the decoupling of the security element from the data-handling system.

The intelligent device may be operable to sense a lack of response to an initiated ping signal to at least one of the data-handling device or the security element in order to detect a decoupling of the security element from the data-handling system. Alternatively, the intelligent device may be operable to sense unpredicted responses to a systematic sequence of initiated ping signals to at least one of the data-handling device or the security element in order to detect a decoupling of the security element from the data-handling system.

In accordance with one or more further aspects of the present invention, a security element may be operatively connectable between an external data path and a data-handling system via a data path, wherein: (i) the security element establishes the data path as a trusted path, (ii) the security element is disposed in a separate physical housing from the data-handling system and an associated storage device, and (iii) the data path is encased in an armored sheath operable to substantially resist access to the data path by unauthorized entities.

Other aspects features and advantages of the present invention will become apparent to those of ordinary skill in the art when the description herein is taken in conjunction with the accompanying drawings.

### BRIEF DESCRIPTION OF THE DRAWINGS

For the purposes of illustration, forms are shown in the drawings that are preferred, it being understood that the invention is not limited to precise arrangements or instrumentalities shown.

FIG. 1 is a block diagram of a computer system having a security element in accordance with the prior art;

FIG. 2 is a block diagram of a computer system having a security element in accordance with one or more aspects of the present invention; and

FIG. 3. is a partial block diagram and partial perspective diagram illustrating an alternative security feature for a computer system in accordance with one or more further aspects of the present invention.

### DETAILED DESCRIPTION OF THE PREFERED EMBODIMENTS

While the invention is not limited to any theory of operation, it is noted that security of data in a computing system is ultimately dependent on the physical security of the equipment containing the data storage elements of the system. For example, a disk/storage system may be physically removed from the equipment and breached. In addition, the security of the data is dependent on the physical security of any data paths or cables carrying the data to and from the data storage element.

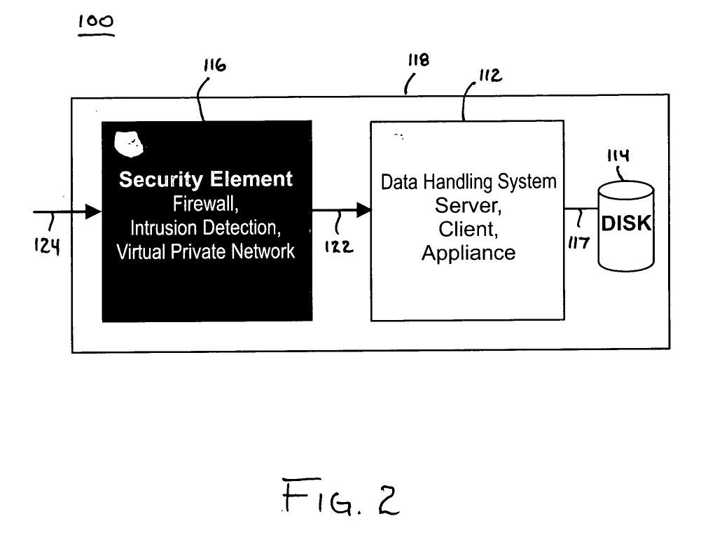

In this regard, reference is now made to FIG. 2, which is a block diagram of a computer system having a security element in accordance with one or more aspects of the present invention. In accordance with this embodiment of the invention, it is desirable to assure that intrusion is difficult by requiring a breech of physical security, which creates evidence of intrusion, into the trusted environment. In this regard, it is preferred that every server include a security element inside its housing, which is locked or sealed.

As shown in FIG. 2, a computer system 100 in accordance with some aspects of the present invention includes a data-handling system 112 (such as one or more servers, clients, PDA's, laptops, notebooks, etc.), a storage device 114 (e.g., a database), and a security element 116. Notably, the server 112, the database 114, and the security element 116 are housed in the same physical cabinet 118. As the security element 116 is operatively coupled between the secure data path 124 and the server 12, the un-secure data path 122 therebetween is within the cabinet 118. Thus, intrusion and access to sensitive data would require breech of the physical cabinet 118, typically setting alarms or recording status by well understood means. It is noted that the security element 116 is physically protected as well as the database 114. Moreover, the unsecured path 122 for information is inside the physical cabinet 118 and not accessible.

It is noted that the security element 116 may be a firewall, a VPN, an IDS, or any combination thereof. The computer system may also include: (i) a virus screen in connection with each protected system, (ii) a URL filter in connection with each protected system, (iii) a spam filter in connection with each protected system, and/or (iv) a fire door in connection with each protected system. The details of the fire door may be found in co-pending U.S. patent application Publication No.: 20030074578, Ser. No. 10/005,886, filed Apr. 17, 2003, entitled COMPUTER VIRUS CONTAINMENT, the entire disclosure of which is hereby incorporated by reference.

Although in theory, the security element 116 may be either a hardware or software system, the software solution is not preferred as it potentially may interact with the server's 112 application program. In some instances use of a software solution may cause either loss of performance or loss of availability of the server 112. Further, the security functions and server functions are often administered by separate functions in many organizations making a logically discrete system attractive from an administration point of view.

On the other hand, a hardware solution provides logical isolation from the protected system. The hardware can run a dissimilar operating system (as compared with the server 112) and may survive even if the protected system is hung, stopped or rebooting. This is in contrast to a software solution, including those with hardware accelerator cards, which cannot achieve this functionality.

As the use of a software solution presents issues, with respect to compatibility with the protected server 112, achieving secure data lines may require physical security and a separate secured hardware platform to protect against internal intruders.

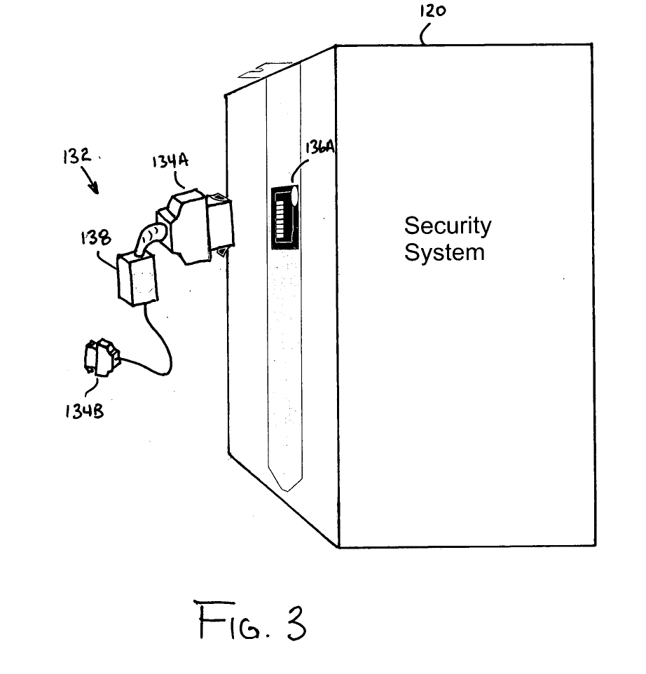

Reference is now made to FIG. 3, which is a partial block diagram and a partial perspective diagram illustrating an alternative security feature of a computer system in accordance with one or more further aspects of the present invention. In accordance with this embodiment of the invention, it is desirable to assure that intrusion is difficult by requiring a breech of a substantially indelible connection between at least some computing components. Again, this creates evidence of intrusion into the trusted environment.

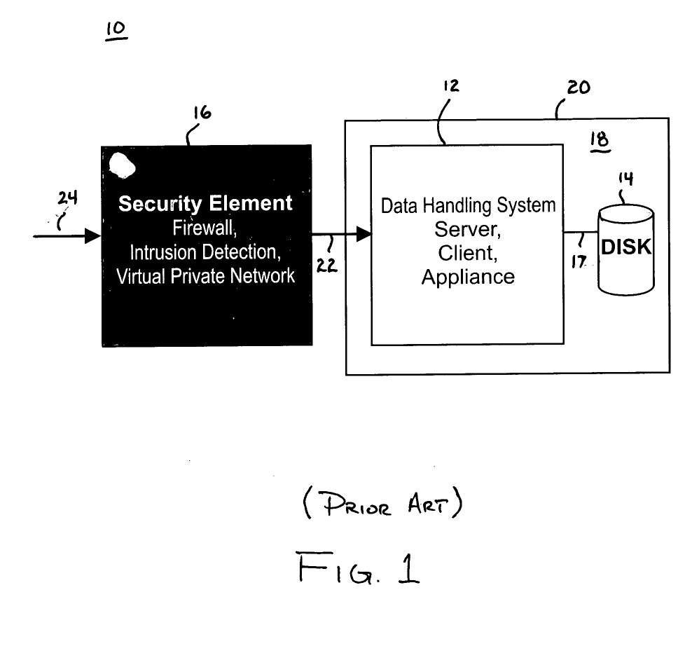

As shown in FIG. 3, a security system 120 may be external to a protected system (not shown). The protected system may be implemented using the system within physical cabinet 18 (FIG. 1). In accordance with this embodiment of the invention the conventionally unsecured path between the security system 120 and the protected system 18 is physically secured. In other words, in accordance with this aspect of the invention, the network 22 of FIG. 1 is physically hardened and rigidly attached to the protected system 18.

For example, the data path (or network) 132 between the security system 120 and the protected system 18 may be formed from a cable within an armored sheath to mitigate against tapping into the data traversing the cable. Preferably, respective connectors 134A and 134B at the ends of the cable each include one or more barbs that substantially resist removal of the connectors from their mating connectors, such as connector 136A. The barbs may be formed from a flexible yet sturdy metal that is biased in an outward direction away from the connectors 134A, B. The mating connectors (e.g., connector 136A) may include one or more corresponding ridges, channels, protrusions, etc. that engage the one or more barbs to fixedly couple the connectors 134, 136 together.

In a preferred embodiment, the forced removal of, for example, the connector 134A from the corresponding mating connectors 136A results in the self-destruction of at least the connector 136A. A similar arrangement is also preferably employed on the opposite end of the cable.

In another embodiment of the invention, the cable includes an intelligent device 138 coupled along the cable that is operable to sound an alarm and/or record the physical intrusion if the cable is removed. The intelligence device 138 may be implemented using well known circuitry for sensing a lack of current to receiving drivers in either the security system 120 or protected system 18. Upon sensing lack of current flow, the alarm may be set. The alarm may be directed to a specific network address. In an alternative embodiment, upon sensing loss of current, the intelligent device 138 is preferably operable to open the data link with a fusible circuit. The fusible link may or may not be resetable. Thus, the forced removal of one of the connectors preferably disables the computer system 18 until it can be physically secured again.

In a further alternative embodiment, the intelligent device 138 may employ any of the known “ping” initiator and reception circuits that sends a ping to the receiving network control in either the security system 120 and/or the protected system 18, and sets an alarm (or take other action) by sensing that no response to the ping is received. It is noted that the ping may be any stimulus at one or more positions along the data path or cable (preferably the position being at one end) in order to create a response by the data path or cable. The ping may be any manner of systematic or random signals that can be recognized as originating at a position along cable. For example, this ping circuit may alternatively be sensitive to unpredicted responses to a systematic sequence of pings. Although a complete characterization of suitable ping signals would be unduly lengthy, by way of example, the ping could be an encrypted message that is not easily duplicated by intervening equipment.

It is noted that having the security element internalized (as opposed to a removable PC card, for example) is advantageous for use in connection with mobile systems, e.g., laptops, PDAs, etc. Further, the security element may be intelligent, or may be a hardwired function without a microprocessor, such as is the case of the controller on a printer or other peripheral appliance (which may have an internal controller or logic for security).

It is noted that the security aspects discussed with respect to FIG. 3 may be extended to other embodiments of the invention. For example, any of the elements of the computer system (e.g., the data-handling device 112, the security element 116, the data storage device 114, any communication systems (not shown), and/or any peripheral systems (not shown) may be disposed remotely from one another (e.g., in separate cabinets, in separate rooms, etc. Thus, for example, the data path 132 (or cable) as described above may be utilized to interconnect any or all of these system elements together to achieve desirable security levels.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A computer system, comprising:
a data-handling system operable to receive and transmit data over a data path;
a storage device operatively coupled to the data-handling system to receive data from and deliver stored data to the data-handling system; and
a security element operatively coupled between an external data path and the data-handling system via the data path, the security element establishing the data path as a trusted path,
wherein the data-handling system, the storage device and the security element are disposed in a common physical housing such that access to the data path requires breach of the housing.

2. The computer system of claim 1, wherein the data-handling system includes one or more servers, client terminals, and/or databases.

3. The computer system of claim 1, wherein the security element is one of a hardware solution and a software solution.
(VPN) to shield one or more servers (e.g., banks of servers or individual servers). Intrusion Detection Systems (IDSs)

4. The computer system of claim 1, wherein the security device is operable to establish at least one of (i) a firewall function, (ii) a virtual private network function, (iii) an intrusion detection system function, (iv) a virus screen function, (v) a URL filter function, (vi) a spam filter function, and (vii) a fire door function.

5. A computer system, comprising:
a data-handling system operable to receive and transmit data over a data path;
a storage device operatively coupled to the data-handling system to receive data from and deliver stored data to the data-handling system; and
a security element operatively coupled between an external data path and the data-handling system via the data path, the security element establishing the data path as a trusted path,
wherein the security element is disposed in a separate physical housing from the data-handling system and the storage device, and the data path is encased in an armored sheath operable to substantially resist access to the data path by unauthorized entities.

6. The computer system of claim 5, further comprising one or more anti-tamper devices integrated with one or more connectors of the data path, the anti-tamper devices resisting removal of the one or more connectors from at least one of the data-handling system and the security device.

7. The computer system of claim 6, wherein the anti-tamper devices are operable to permanently damage at least one of themselves and mating connectors thereof in order to substantially resist access to the data path by unauthorized entities.

8. The computer system of claim 6, wherein the anti-tamper devices include at least one barb that interlocks with a mating element of a mating connector such that the connector may not be removed from the mating connector without damaging at least one of the connector and mating connector in order to substantially resist access to the data path by unauthorized entities.

9. The computer system of claim 8, wherein:
the at least one barb is formed from a flexible yet sturdy metal that is biased in an outward direction away from the connector; and
the mating connector includes one or more corresponding ridges, channels, and/or protrusions that engage the at least one barb to fixedly couple the connector and the mating connector together.

10. The computer system of claim 5, further comprising an intelligent device coupled along the data path that is operable to detect a decoupling of the security element from the data-handling system and to take action in response.

11. The computer system of claim 10, wherein the intelligent device is operable to sound an alarm when decoupling of the security element from the data-handling system is detected.

12. The computer system of claim 10, wherein the alarm may be directed to a specific network address.

13. The computer system of claim 10, wherein the intelligent device is operable to record that decoupling of the security element from the data-handling system is detected.

14. The computer system of claim 10, wherein the intelligent device is operable to sense a lack of current to receiving drivers in either the data-handling device or the security element in order to detect a decoupling of the security element from the data-handling system.

15. The computer system of claim 10, wherein the intelligent device is operable to open the data path between the data-handling device and the security element in response to a decoupling of the security element from the data-handling system.

16. The computer system of claim 15, wherein the intelligent device is operable to open a fusible circuit in response to the decoupling of the security element from the data-handling system.

17. The computer system of claim 10, wherein the intelligent device is operable to sense a lack of response to an initiated ping signal to at least one of the data-handling device or the security element in order to detect a decoupling of the security element from the data-handling system.

18. The computer system of claim 10, wherein the intelligent device is operable to sense unpredicted responses to a systematic sequence of initiated ping signals to at least one of the data-handling device or the security element in order to detect a decoupling of the security element from the data-handling system.

19. The computer system of claim 5, wherein the data-handling system includes one or more servers, client terminals, and/or databases.

20. The computer system of claim 5, wherein the security element is one of a hardware solution and a software solution.

21. The computer system of claim 5, wherein the security device is operable to establish at least one of (i) a firewall function, (ii) a virtual private network function, (iii) an intrusion detection system function, (iv) a virus screen function, (v) a URL filter function, (vi) a spam filter function, and (vii) a fire door function.

22. A security element operatively connectable between an external data path and a data-handling system via a data path, wherein: (i) the security element establishes the data path as a trusted path, (ii) the security element is disposed in a separate physical housing from the data-handling system and an associated storage device, and (iii) the data path is encased in an armored sheath operable to substantially resist access to the data path by unauthorized entities.

23. The computer system of claim 22, further comprising one or more anti-tamper devices integrated with one or more connectors of the data path, the anti-tamper devices resisting removal of the one or more connectors from at least one of the data-handling system and the security device.

24. The computer system of claim 23, wherein the anti-tamper devices are operable to permanently damage at least one of themselves and mating connectors thereof in order to substantially resist access to the data path by unauthorized entities.

25. The computer system of claim 23, wherein the anti-tamper devices include at least one barb that interlocks with a mating element of a mating connector such that the connector may not be removed from the mating connector without damaging at least one of the connector and mating connector in order to substantially resist access to the data path by unauthorized entities.

26. The computer system of claim 25, wherein:
the at least one barb is formed from a flexible yet sturdy metal that is biased in an outward direction away from the connector; and
the mating connector includes one or more corresponding ridges, channels, and/or protrusions that engage the at least one barb to fixedly couple the connector and the mating connector together.

27. The computer system of claim 22, further comprising an intelligent device coupled along the data path that is operable to detect a decoupling of the security element from the data-handling system and to take action in response.

28. The computer system of claim 27, wherein the intelligent device is operable to sound an alarm when decoupling of the security element from the data-handling system is detected.

29. The computer system of claim 27, wherein the alarm may be directed to a specific network address.

30. The computer system of claim 27, wherein the intelligent device is operable to record that decoupling of the security element from the data-handling system is detected.

31. The computer system of claim 27, wherein the intelligent device is operable to sense a lack of current to receiving drivers in either the data-handling device or the security element in order to detect a decoupling of the security element from the data-handling system.

32. The computer system of claim 27, wherein the intelligent device is operable to open the data path between the data-handling device and the security element in response to a decoupling of the security element from the data-handling system.

33. The computer system of claim 32, wherein the intelligent device is operable to open a fusible circuit in response to the decoupling of the security element from the data-handling system.

34. The computer system of claim 27, wherein the intelligent device is operable to sense a lack of response to an initiated ping signal to at least one of the data-handling device or the security element in order to detect a decoupling of the security element from the data-handling system.

35. The computer system of claim 27, wherein the intelligent device is operable to sense unpredicted responses to a systematic sequence of initiated ping signals to at least one of the data-handling device or the security element in order to detect a decoupling of the security element from the data-handling system.

36. The computer system of claim 22, wherein the security element is one of a hardware solution and a software solution.

37. The computer system of claim 22, wherein the security device is operable to establish at least one of (i) a firewall function, (ii) a virtual private network function, (iii) an intrusion detection system function, (iv) a virus screen function, (v) a URL filter function, (vi) a spam filter function, and (vii) a fire door function.

38. A security cable operatively connectable between a security element and a data-handling system to establish a data path therebetween, wherein: (i) the security element establishes the data path as a trusted path, (ii) the security element is disposed in a separate physical housing from the data-handling system and an associated storage device, and (iii) the data path is encased in an armored sheath operable to substantially resist access to the data path by unauthorized entities.

39. The security cable of claim 38, further comprising one or more anti-tamper devices integrated with one or more connectors of the data path, the anti-tamper devices resisting removal of the one or more connectors from at least one of the data-handling system and the security device.

40. The security cable of claim 39, wherein the anti-tamper devices are operable to permanently damage at least one of themselves and mating connectors thereof in order to substantially resist access to the data path by unauthorized entities.

41. The security cable of claim 39, wherein the anti-tamper devices include at least one barb that interlocks with a mating element of a mating connector such that the connector may not be removed from the mating connector without damaging at least one of the connector and mating connector in order to substantially resist access to the data path by unauthorized entities.

42. The security cable of claim 41, wherein:
the at least one barb is formed from a flexible yet sturdy metal that is biased in an outward direction away from the connector; and
the mating connector includes one or more corresponding ridges, channels, and/or protrusions that engage the at least one barb to fixedly couple the connector and the mating connector together.

43. The security cable of claim 38, further comprising an intelligent device coupled along the data path that is operable to detect a decoupling of the security element from the data-handling system and to take action in response.

44. The security cable of claim 43, wherein the intelligent device is operable to sound an alarm when decoupling of the security element from the data-handling system is detected.

45. The security cable of claim 43, wherein the alarm may be directed to a specific network address.

46. The security cable of claim 43, wherein the intelligent device is operable to record that decoupling of the security element from the data-handling system is detected.

47. The security cable of claim 43, wherein the intelligent device is operable to sense a lack of current to receiving drivers in either the data-handling device or the security element in order to detect a decoupling of the security element from the data-handling system.

48. The security cable of claim 43, wherein the intelligent device is operable to open the data path between the data-handling device and the security element in response to a decoupling of the security element from the data-handling system.

49. The security cable of claim 48, wherein the intelligent device is operable to open a fusible circuit in response to the decoupling of the security element from the data-handling system.

50. The security cable of claim 43, wherein the intelligent device is operable to sense a lack of response to an initiated ping signal to at least one of the data-handling device or the security element in order to detect a decoupling of the security element from the data-handling system.

51. The security cable of claim 43, wherein the intelligent device is operable to sense unpredicted responses to a systematic sequence of initiated ping signals to at least one of the data-handling device or the security element in order to detect a decoupling of the security element from the data-handling system.

52. A computer system, comprising:
a data-handling system operable to receive and transmit data over a first data path;
a storage device operatively coupled to the data-handling system via a second data path to receive data from and deliver stored data to the data-handling system; and
a security element operatively coupled between an external data path and the data-handling system via the data path, the security element establishing the data path as a trusted path,
wherein at least one of the data-handling system, the storage device, and the security element is disposed in a separate physical housing from the other elements of the system, and one or more of the data paths are encased in an armored sheath operable to substantially resist access to the data path by unauthorized entities.

53. The computer system of claim 52, further comprising one or more anti-tamper devices integrated with one or more connectors of the data path, the anti-tamper devices resisting removal of the one or more connectors from at least one of the data-handling system and the security device.

54. The computer system of claim 53, wherein the anti-tamper devices are operable to permanently damage at least one of themselves and mating connectors thereof in order to substantially resist access to the data path by unauthorized entities.

55. The computer system of claim 53, wherein the anti-tamper devices include at least one barb that interlocks with a mating element of a mating connector such that the connector may not be removed from the mating connector without damaging at least one of the connector and mating connector in order to substantially resist access to the data path by unauthorized entities.

56. The computer system of claim 55, wherein:
the at least one barb is formed from a flexible yet sturdy metal that is biased in an outward direction away from the connector; and
the mating connector includes one or more corresponding ridges, channels, and/or protrusions that engage the at least one barb to fixedly couple the connector and the mating connector together.

57. The computer system of claim 52, further comprising an intelligent device coupled along the data path that is operable to detect a decoupling of the security element from the data-handling system and to take action in response.

58. The computer system of claim 57, wherein the intelligent device is operable to sound an alarm when decoupling of the security element from the data-handling system is detected.

59. The computer system of claim 57, wherein the alarm may be directed to a specific network address.

60. The computer system of claim 57, wherein the intelligent device is operable to record that decoupling of the security element from the data-handling system is detected.

61. The computer system of claim 57, wherein the intelligent device is operable to sense a lack of current to receiving drivers in either the data-handling device or the security element in order to detect a decoupling of the security element from the data-handling system.

62. The computer system of claim 57, wherein the intelligent device is operable to open the data path between the data-handling device and the security element in response to a decoupling of the security element from the data-handling system.

63. The computer system of claim 57, wherein the intelligent device is operable to open a fusible circuit in response to the decoupling of the security element from the data-handling system.

64. The computer system of claim 57, wherein the intelligent device is operable to sense a lack of response to an initiated ping signal to at least one of the data-handling device or the security element in order to detect a decoupling of the security element from the data-handling system.

65. The computer system of claim 57, wherein the intelligent device is operable to sense unpredicted responses to a systematic sequence of initiated ping signals to at least one of the data-handling device or the security element in order to detect a decoupling of the security element from the data-handling system.
